(19) United States
(12) Patent Application Publication
(10) Pub. No.: US 2026/0046012 A1
(43) Pub. Date: Feb. 12, 2026

(54) PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Hamed PEZESHKI, San Diego, CA (US)

(21) Appl. No.: 19/100,912

(22) PCT Filed: Sep. 22, 2022
(86) PCT No.: PCT/CN2022/120399

§ 371 Date: Feb. 3, 2025

(51) Int. Cl. H04B 7/06; H04B 17/318

(52) U.S. Cl. CPC H04B 7/06968; H04B 7/0617; H04B 7/0626; H04B 17/328

(57) ABSTRACT

A UE may receive, from a network node, information indicating at least one virtual QCL resource corresponding to at least one beam of a set of beams. The at least one beam may be excluded from a subset of beams of the set of beams via which a set of reference signals is respectively received. The UE may determine at least one parameter of the set of beamforming parameters based on at least one of a shape of a first beam of the subset of beams via which a first RS of the set of RSs is received or a direction of the first beam. The UE may apply the set of beamforming parameters associated with the at least one beam based on the at least one virtual QCL resource and receiving the first RS of the set of RSs via the first beam of the subset of beams.

### BACKGROUND

### Technical Field

The present disclosure generally relates to communication systems, and more particularly, to identification of virtual beams using measurements from physical beams for communication between user equipment (UE) and network nodes in wireless communications systems.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive, from a network node, information indicating at least one virtual quasi-colocation (QCL) resource corresponding to at least one beam of a set of beams. The at least one beam may be excluded from a subset of beams of the set of beams via which a set of reference signals is respectively received. The apparatus may determine at least one parameter of the set of beamforming parameters based on at least one of a shape of a first beam of the subset of beams via which a first reference signal (RS) of the set of RSs is received or a direction of the first beam. The apparatus may apply the set of beamforming parameters associated with the at least one beam based on the at least one virtual QCL resource and receiving the first RS of the set of RSs via the first beam of the subset of beams.

In another aspect of the disclosure, another method, another computer-readable medium, and another apparatus are provided. The other apparatus may transmit, to a user equipment (UE), information indicating at least one virtual QCL resource corresponding to at least one beam of a set of beams with which to communicate with the UE. The other apparatus may further transmit, to the UE, a set of reference signals on a subset of beams of the set of beams, the at least one beam being excluded from the subset of beams of the set of beams via which the set of reference signals is respectively transmitted.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating an example disaggregated base station architecture.

FIG. 3A is a diagram illustrating an example of a first frame, in accordance with various aspects of the present disclosure.

FIG. 3B is a diagram illustrating an example of downlink channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink channels within a subframe, in accordance with various aspects of the present disclosure.

FIG. 4 is a diagram illustrating an example of a base station and user equipment (UE) in an access network.

FIG. 5 is a diagram illustrating an example of spatial domain beam prediction.

FIG. 6 is a block diagram illustrating an example of relationships between beamforming parameters.

FIG. 7 is a diagram illustrating an example of a configuration 700 for CSI reporting by a UE.

FIG. 8 is a block diagram illustrating example configurations of resource patterns for virtual QCL resources.

FIG. 9 is a block diagram illustrating example configurations of resource patterns for virtual QCL resources.

FIG. 10 is a flowchart illustrating an example of a method of wireless communication at a UE.

FIG. 11 is a flowchart illustrating an example of a method of wireless communication at a network node.

FIG. 12 is a diagram illustrating an example of a hardware implementation for an example apparatus.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

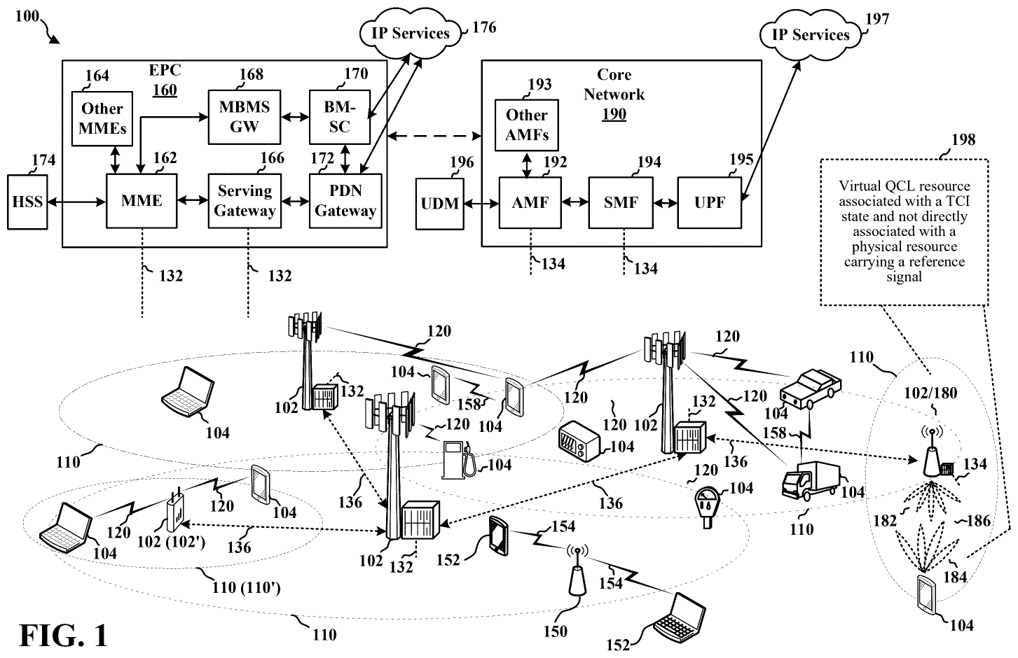

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells, such as high power cellular base stations, and/or small cells, such as low power cellular base stations (including femtocells, picocells, and microcells).

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as the Next Generation Radio Access Network (RAN) (NG-RAN), may interface with a core network 190 through second backhaul links 134. In addition to other functions, the base stations 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

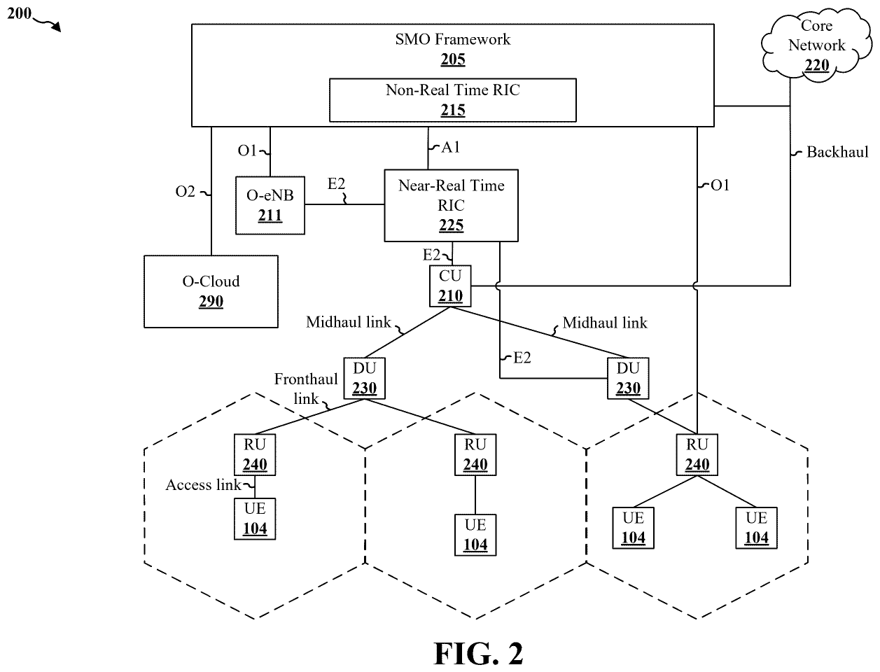

At least some of the base stations 102 configured for IAB may have a split architecture including multiple units, some or all of which may be collocated or distributed and which may communicate with one another. For example, FIG. 2, infra, illustrates an example disaggregated base station 200 architecture that includes at least one of a central unit (CU) 210, a distributed unit (DU) 230, a radio unit (RU) 240, a remote radio head (RRH), a remote unit, and/or another similar unit configured to implement one or more layers of a radio protocol stack.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cells and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102 may be implemented as a macro base station providing a large cell or may be implemented as a small cell 102′having a small cell coverage area. Some base stations 102 may operate in a traditional sub-6 GHz (or sub-7 GHz) spectrum, in mmW frequencies, and/or near-mmW frequencies in communication with the UE 104. When such a base station operates in mmW or near-mmW frequencies, the base station may be referred to as a mmW base station 180. The mmW base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may receive, from a base station 102/180, information indicating at least one virtual quasi-colocation (QCL) resource 198 corresponding to at least one beam of a set of beams. The at least one beam may be excluded from a subset of beams of the set of beams via which a set of reference signals is respectively received. The UE 104 may determine at least one parameter of the set of beamforming parameters based on at least one of a shape of a first beam of the subset of beams via which a first reference signal (RS) of the set of RSs is received or a direction of the first beam. The UE 104 may apply the set of beamforming parameters associated with the at least one beam based on the at least one virtual QCL resource and receiving the first RS of the set of RSs via the first beam of the subset of beams.

The base station 102/180 may transmit, to the UE 104, information indicating the at least one virtual QCL resource 198 corresponding to at least one beam of a set of beams with which to communicate with the UE 104. The base station 102/180 may further transmit, to the UE 104, a set of reference signals on a subset of beams of the set of beams, the at least one beam being excluded from the subset of beams of the set of beams via which the set of reference signals is respectively transmitted.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 2 shows a diagram illustrating an example disaggregated base station 200 architecture. Deployment of communication systems, such as 5G NR systems, may be arranged in multiple manners with various components or constituent parts. In a 5G NR system, or network, a network node, a network entity, a mobility element of a network, a RAN) node, a core network node, a network element, or a network equipment, such as a base station, or one or more units (or one or more components) performing base station functionality, may be implemented in an aggregated or disaggregated architecture. For example, a base station may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 200 architecture may include one or more CUs 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links. In some implementations, the UE 104 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

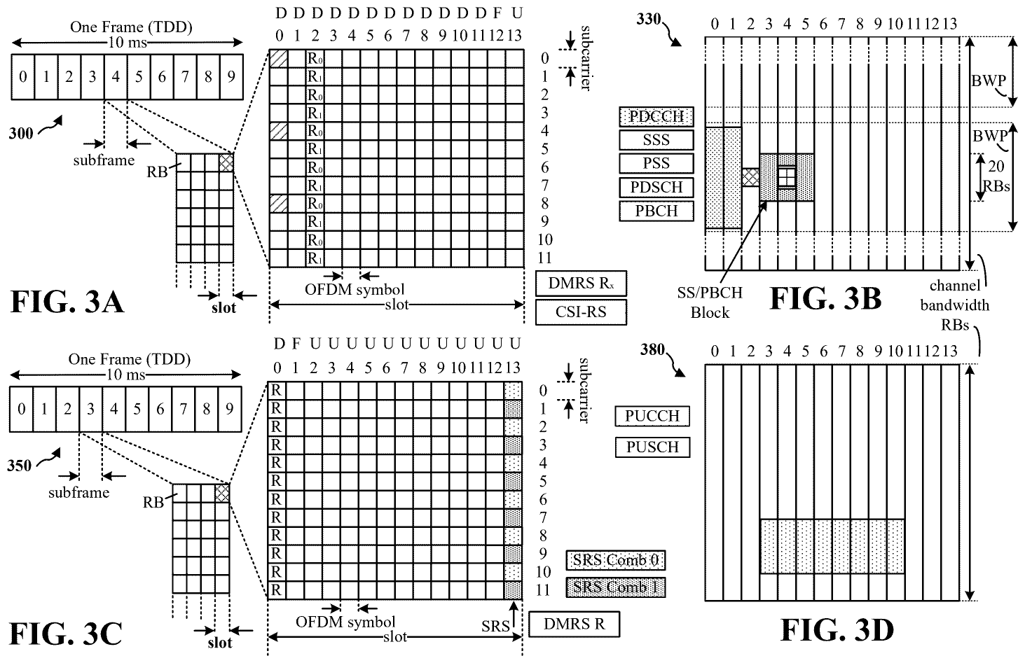

FIG. 3A is a diagram illustrating an example of a first subframe 300 within a 5G NR frame structure. FIG. 3B is a diagram illustrating an example of downlink channels within a 5G NR subframe 330. FIG. 3C is a diagram illustrating an example of a second subframe 350 within a 5G NR frame structure. FIG. 3D is a diagram illustrating an example of uplink channels within a 5G NR subframe 380. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 3A and 3C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 3D illustrates an example of various uplink channels within a subframe of a frame. The PUCCH may be located as indicated in one configuration. The PUCCH carries uplink control information (UCI), which may include one or more of a scheduling request (SR), a channel quality indicator (CQI), a precoding matrix indicator (PMI), a rank indicator (RI), a layer indicator (LI), and/or hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

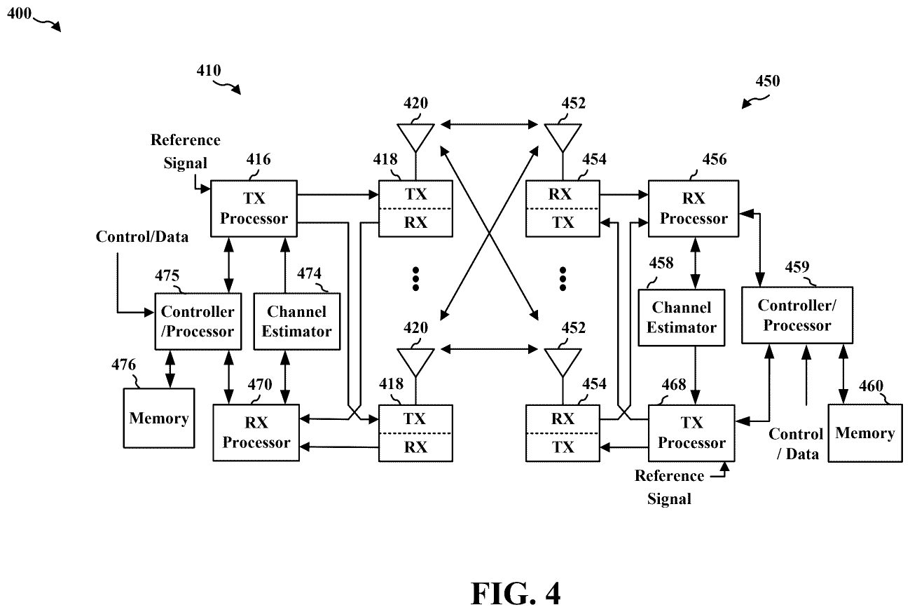

FIG. 4 is a block diagram of a base station 410 in communication with a UE 450 in an access network 400. In the downlink, IP packets from the EPC 160 may be provided to a controller/processor 475. The controller/processor 475 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate a radio frequency (RF) carrier with a respective spatial stream for transmission.

At the UE 450, each receiver 454RX receives a signal through at least one respective antenna 452. Each receiver 454RX recovers information modulated onto an RF carrier and provides the information to the receive (RX) processor 456. The TX processor 468 and the RX processor 456 implement L1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements L3 and L2 functionality.

The controller/processor 459 can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the downlink transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The uplink transmission is processed at the base station 410 in a manner similar to that described in connection with the receiver function at the UE 450. Each receiver 418RX receives a signal through at least one respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the uplink, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

In some aspects, at least one of the TX processor 468, the RX processor 456, and the controller/processor 459 may be configured to perform aspects in connection with the virtual QCL resource 198 of FIG. 1.

In some other aspects, at least one of the TX processor 416, the RX processor 470, and the controller/processor 475 may be configured to perform aspects in connection with the virtual QCL resource 198 of FIG. 1.

Beamformed communication between a network node and a UE is often configured via a beam management procedure in which the qualities or channel conditions on beams is identified via measurements provided by the UE. With beamformed communication, the performance (e.g., beam quality, accuracy, etc.) of a beam may be proportional to the amount of power used to generate and transmit on a beam. However, the consumption of power increases overhead costs, and so limitations may be placed upon the amount of power (or overhead) that can be used. In addition, the signaling on a beam may incur some overhead in terms of latency, such as when throughput is reduced due to beam switching or recovery from radio link failure.

One approach to reducing the overhead incurred in relation to beam management procedures includes predictive beam management, which may be implemented in one or more of the time domain, frequency domain, or spatial domain. With predictive beam management, the qualities or channel conditions may be estimated or predicted for beams on which reference signals are not transmitted (which precludes physical measurements). Such predicted beam qualities may be used to improve the accuracy and reduce the amount of power used to transmit some signaling, thereby reducing the overhead.

In addition, predictive beam management may enable the anticipation of future beam blockages or failures so that radio link failures can be avoided by switching prior to such failure occurring. Such preventative or preemptive measures may reduce the latency that would otherwise be experienced without predictive beam management, and therefore, may improve throughput.

Beam prediction is an inherently non-linear process. For example, predicting the quality of a Tx beam is dependent upon the speed, trajectory, etc. of the receiver (e.g., a UE), as well as the Rx beam used (or to be used) by the receiver, interference on the channel, and other such factors. Effectively, many real-world factors affecting beam quality are interpreted as random (or nearly random) variables because those factors are so multivariate and uncontrollable that conventional statistical signal processing methods are unable to produce accurate models. Thus, one approach to such beam prediction includes the implementation of artificial intelligence (AI) or machine learning (ML).

In order to implement AI/ML for beam prediction, a neural network or AI/ML model may be employed at one or both of the transmitter and/or the receiver. For example, an AI/ML model may be locally or remotely accessible by a network node and/or a UE. Illustratively, a UE generally collects a greater number of measurements than a network node, as network nodes are often configured to instruct UEs to transmit certain measurements to the network nodes under various circumstances and/or at various times. Due to the volume of measurements collected by UEs, implementing an AI/ML model at the UE side may be reasonably expected to provide more accurate beam predictions. While the present disclosure describes the concepts and various aspects in the context of implemented an AI/ML model at the UE side, one of ordinary skill in the relevant art would appreciate that AI/ML models can be implemented in any system, including a network node.

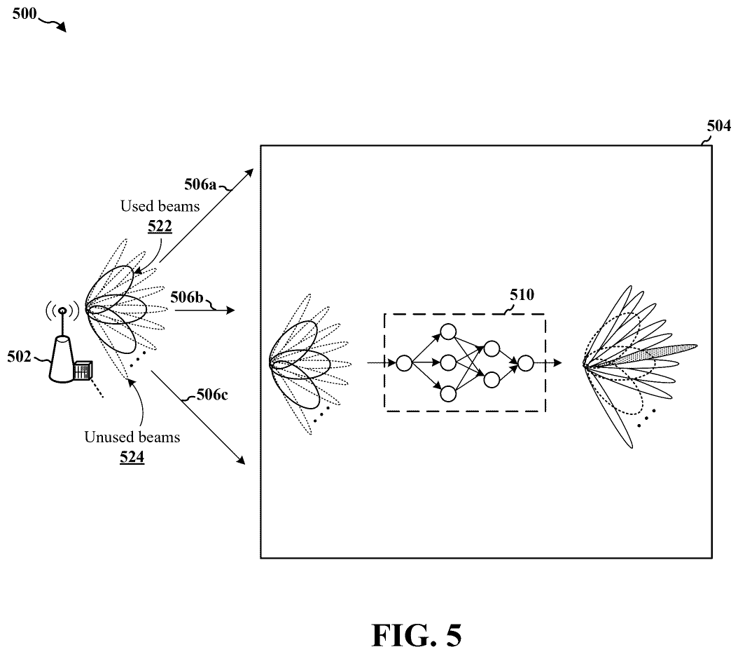

FIG. 5 is a diagram illustrating an example of spatial domain beam prediction 500. The beam prediction 500 may be carried out by a UE 504 configured to receive RSs 506a, 506b, 506c (collectively, 506a-506c) from a network node 502. In the context of FIGS. 1, 2, and 4, the network node 502 may be an implementation of the base station 102/180, the CU 210, DU 230, and/or RU 240, and/or the base station 410, respectively, and the UE 504 may be an implementation of the UE 104 and/or the UE 450.

The UE 504 may be configured with an AI/ML model 510 (e.g., a neural network, an AI/ML algorithm trained on some dataset, etc.). The network node 502 may transmit be configured to generate a set of beams 522 via which the network node 502 may respectively transmit a set of RSs 506a-506c (e.g., SSBs and/or CSI-RSs). Accordingly, the beams on which RSs 506a-506c are transmitted for one prediction period (e.g., a burst, a scheduled transmission, a beam management procedure, etc.) may be referred to as “physical”beams 522.

In some aspects, the physical beams 522 generated by the network node 502 may be considered “wide” beams or “coarse” beams, e.g., because the network node 502 may be capable of generating other beams that are narrower or finer (and perhaps more accurate) than the physical beams 522. However, the network node 502 may refrain from generating such other beams. As the network node 502 may refrain from transmitting any RSs on the other beams for the prediction period (e.g., the burst, the scheduled transmission, the beam management procedure, etc.) while still being able to do so, the other beams may be referred to as “virtual” beams 524. In some aspects, the virtual beams 524 may be narrow beams or fine beams, e.g., relative to the physical beams 522. In some aspects, the virtual beams 524 may be beams that otherwise would have had measurements performed therefrom if RSs (e.g., CSI-RSs) were transmitted on those beams, such as if the AI/ML model 510 were absent and no mechanism existed for beam prediction.

The UE 504 may receive the RSs 506a-506c (e.g., SSBs, CSI-RSs, etc.), and the UE 504 may perform various measurements and/or calculations in order to determine report quantities or other values. For example, the UE 504 may determine (e.g., measure, calculate, etc.) one or more of a reference signal receive power (RSRP) (e.g., an L1-RSRP), a reference signal receive quality (RSRQ), a signal-to-noise ratio (SNR), a signal-to-interference-plus-noise ratio (SINR) (e.g., an L1-SINR), a precoding matrix indicator (PMI), a rank indicator (RI), a layer indicator (LI), channel quality information (CQI), and/or other measurements or calculations.

When an AI/ML model 510 is implemented at the UE side, the UE 504 may provide the RSs 506a-506c to the AI/ML model 510 as input. As a one-to-one relationship exists between each of the RSs 506a-506c that correspond to a respective one of the physical beams 522, the physical beams 522 may be viewed as an input set of beams. The AI/ML model 510 may produce a result from the input set of beams (here, the physical beams 522), and the result may include one or more of the virtual beams 524. That is, the AI/ML model 510 may estimate or predict the qualities or channel conditions of some or all virtual beams 524 based on the physical RSs 506a-506c carried on the generated and physical beams 522.

In some aspects, the UE 504 may use the AI/ML model 510 to estimate or predict one or more measurements for some or all of the virtual beams 524 by providing one or more measurements observed by the UE 504 for some or all of the physical beams 522 via which the UE 504 receives the (physical) RSs 506a-506c. For example, the UE 504 may provide the RSRPs (e.g., L1-RSRPs) measured from the RSs 506a-506c to the AI/ML model 510 as input, and, in response, the UE 504 may obtain predicted RSRPs (e.g., L1-RSRPs) corresponding to some or all of the virtual beams 524 as output from the AI/ML model 510.

In some aspects, the network node 502 may transmit, and the UE 504 may receive, some beamforming information related to the physical beams 522 generated by the network node 502. For example, the network node 502 may transmit, to the UE 504, information indicating a shape of a beam, an angle of departure (AoD) on a beam, an angle of arrival (AoA) on a beam, a point or direction of a beam (e.g., an elevational angle and/or azimuthal angle), and/or other information related to generating one of the physical beams 522. The UE 504 may receive such beamforming information, and the UE 504 may use the beamforming information to improve the accuracy of the predictions related to the virtual beams 524. For example, the beamforming information may be used to adjust weights of the AI/ML model 510.

In some further aspects, the network node 502 may transmit, and the UE 504 may receive, other beamforming information related to the virtual beams 524. For example, the network node 502 may transmit, to the UE 504, information indicating a shape of a virtual beam, a point or direction of a virtual beam (e.g., an elevational angle and/or azimuthal angle), and/or other information related to generating one of the virtual beams 524. The UE 504 may receive such beamforming information, and the UE 504 may use the beamforming information to improve the accuracy of the predictions related to the virtual beams 524. For example, the beamforming information may be used to adjust weights of the AI/ML model 510.

The UE 504 may report some or all of the output of the AI/ML model 510 to the network node 502. For example, the UE 504 may report some predicted measurements, beams predicted to have a satisfactory quality, etc. In some instances, the network node 502 may transmit, to the UE 504, information indicating the beam of the virtual beams 524 about which the network node 502 is requesting further information. For example, the network node 502 may instruct the UE 504 to report one or more measurements (e.g., L1-RSRP, L1-SINR, etc.) predicted for one or more virtual beams 524. In another example, the network node 502 may transmit, to the UE 504, an indication of a virtual beam 524 that will be generated and used to transmit data to the UE 504, such as a beam via which a PDSCH may be transmitted.

In the foregoing examples and other similar instances, the network node 502 must use some mechanism to identify the beam for which the UE 504 is to predict the measurement(s) or the beam on which the UE 504 is to receive data. For physical beams, a transmission configuration indicator (TCI) state is used to identify a beam. For beamforming, a TCI state may be configured with QCL information of Type D, which includes a set of spatial parameters (e.g., spatial Rx parameters). In some implementations, the network node 502 is able to refer to different physical beams via the RSs that are transmitted hereon. For example, the network node 502 may transmit an SSB identified as “SSB1” on one beam and may subsequently inform the UE 504 of a TCI state referring to SSB1 so that the UE 504 is aware that the same spatial filter used for receiving SSB1 can also be used for receiving signaling that is quasi-collocated with SSB1, where the QCL is QCL Type D.

In order to know the spatial filter that was applied to receive SSB1, however, SSB1 must be received. Because no RSs are transmitted for virtual beams, however, the network node 502 and the UE 504 may lack a mechanism with which to refer to one of the virtual beams 524.

To address this issue, a virtual QCL resource may be substituted in place of an RS resource or the virtual QCL resource may be signaled as an additional QCL type in a TCI state, e.g., in addition to QCL Types A, B, C, and D. Illustratively, a TCI state may indicate a virtual QCL resource rather than an RS resource for QCL Type D. With such an approach, the network node 502 may specifically identify one of the virtual beams 524 to the UE 504 via the virtual QCL resource. The virtual QCL resource may be of particular use for instances in which the network node 502 informs the UE 504 of which beam will be used to receive data on the PDSCH and/or for instances in which the UE 504 is configured for measurement reporting (e.g., L1-RSRP, L1-SINR, etc.) on one or more of the virtual beams 524 that the UE 504 has predicted.

In some aspects, the network node 502 may configure the UE 504 with an SRS resource or SRS resource set. The network node 502 may transmit spatial relation information to the UE for determining a suitable Tx spatial filter for SRS transmission. In some aspects, such spatial relation information may be conveyed as a virtual QCL resource, e.g., in that the virtual QCL resource refers to a mother SRS resource.

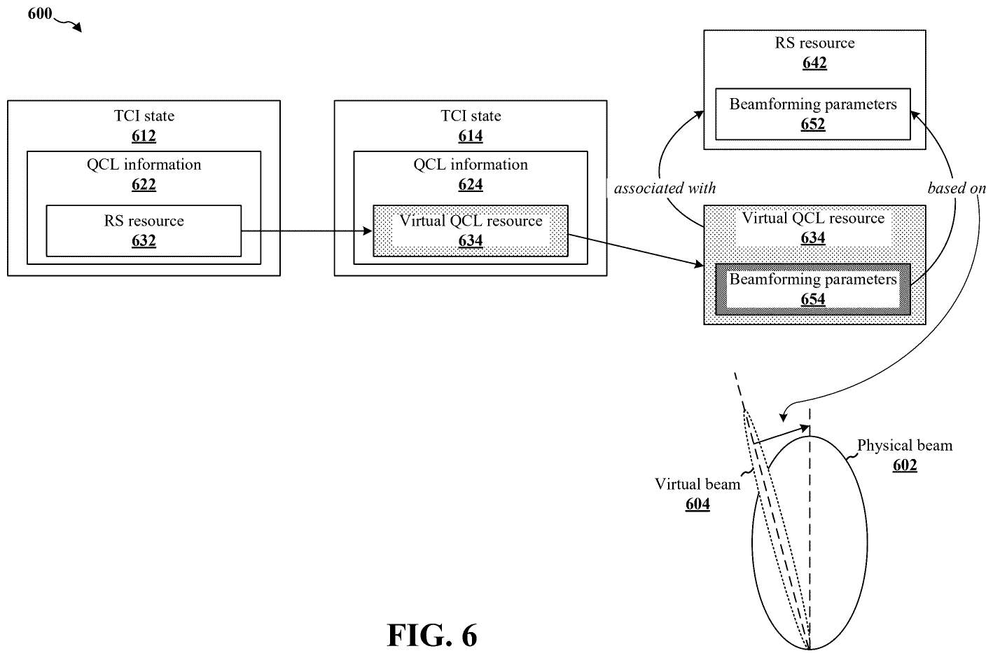

FIG. 6 is a block diagram illustrating an example of relationships 600 between beamforming parameters. In some instances, a TCI state 612 may be included in a DCI message. Within the TCI state 612 may include QCL information 622 configuring various parameters related to QCL, including the QCL type and the RS resource 632 (e.g., SSB, CSI-RS, etc.) to which the TCI state 612. However, the first TCI state 612 refers to a physical beam via which an RS is transmitted, as the spatial filter used by a UE to receive the RS resource 632 will be reused to receive other signaling quasi-collocated with the RS resource 632.

The second TCI state 614 may be included in at least one of an RRC signaling message, a DCI message (e.g., including TCI states different from the first TCI state 612), and/or a MAC control element (CE). In some aspects, the MAC CE may be used to activate or deactivate a particular virtual QCL resource, e.g., after configuration via DCI or RRC signaling. Similar to the first TCI state 612, the second TCI state 614 may include QCL information 624 configuring various parameters related to QCL, including the QCL type. Rather than configure an RS resource, however, the second TCI state 614 may include a virtual QCL resource 634, which may not directly refer to any RS resource (e.g., SSB, CSI-RS, etc.). Rather, the virtual QCL resource 634 may be defined with respect to another RS that is transmitted on another beam (e.g., a physical beam). Thus, while virtual beam information associated with the virtual QCL resource 634 may be derivable from an RS, such virtual beam information may not be directly measurable from an RS. For example, in the context of spatial filtering (e.g., for QCL Type D), a set of spatial filtering parameters may be used to receive an RS via a physical beam. That set of spatial filtering parameters may be used to receive another signal on the physical beam because the channel conditions may be assumed to be appreciably consistent. However, the set of spatial filtering parameters cannot also be used to receive another signal on a virtual beam that is not identical to the physical beam because the channel conditions would be different between the physical beam and the virtual beam.

In some aspects, the virtual QCL resource 634 may be associated with a physical RS resource 642, which may be referred to as a “mother” or “parent” RS resource (e.g., an SSB resource or a CSI-RS resource). Such a physically transmitted RS may be transmitted via a beam 602, which may in turn be at least partially defined by the physically transmitted RS 642. For example, the RS resource 642 (e.g., SSB, CSI-RS, etc.) may be associated with a set of beamforming parameters 652 that may define the physical beam 602.

The UE may be configured to separately identify the beamforming parameters 652 that are related to the physical RS resource 642. For example, a UE may receive an RRC signaling message or other such message, which may indicate the pointing direction and width information of the physical beam 602 transmitting the RS resource 642. The network node may dynamically change some or all of the beamforming parameters 654, such as the beam shape, via at least one of a MAC CE and/or DCI.

Similarly, the virtual QCL resource 634 may be associated with a set of beamforming parameters 654 that may at least partially define a virtual beam 604 corresponding to the virtual QCL resource 634. The beamforming parameters 654 may include, inter alia, beam shape, pointing direction, elevational angle, azimuthal angle, and other similar parameters that may be used to generate and receive or transmit on a beam. Such beamforming parameters 654 may be separately provided to the UE, e.g., by the network node.

As the virtual beam 604 does not have an RS transmitted thereon, and the virtual QCL resource 634 is associated with the physical RS resource 642, the virtual beam 604 may be correspondingly associated with the physical beam 602, which may be referred to as a “mother” or “parent” beam. In particular, the virtual beam 604 may be defined in terms that are relative to the physical beam 602. For example, the beam shape of the virtual beam 604 may be defined as a pointing direction (e.g., +25° in elevation, −10° in azimuth, relative to the pointing direction of the physical beam 602) and a beam width (e.g., 20% of the beam width of the physical beam 602) relative to the physical beam 602. The network node may configure such information at the UE via RRC signaling. For example, information elements (IEs) associated with the virtual QCL resource 634 may be defined to carry such information related to the “mother” RS resource 642 and/or the physical beam 602 that carries such a resource. In some aspects, the beamforming parameters 654 associated with the virtual QCL resource 634 may be dynamically updated via RRC signaling, MAC CE, and/or DCI, which may be associated with a CSI report.

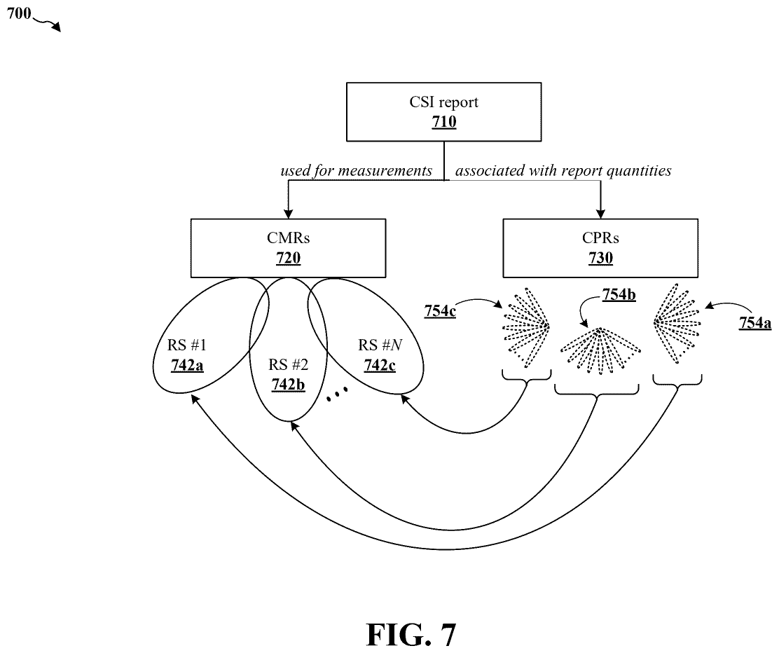

FIG. 7 is a diagram illustrating an example of a configuration 700 for CSI reporting by a UE. As with conventional CSI reporting in which a UE determines one or more report quantities based on receiving RSs from a network node, and transmits CSI reports indicating such report quantities to the network node, a UE may be configured to determine report quantities for virtual QCL resources and report those report quantities to the network node in CSI reports. According to various different aspects, CSI reporting may be periodic, semi-persistent, or aperiodic.

In some aspects, a network node may instruct a UE to report a CSI report 710 in which channel measurement resources (CMRs) 720 associated with the CSI report 710 are based on physical RS resources 742a-742c (e.g., SSB or CSI-RS resources). However, the CSI report 710 may include report quantities related to virtual QCL resources 754a-754c, while the physical RS resources 742a-742c may be “mother” RS resources of the virtual QCL resources 754a-754c.

For the purposes of CSI reporting, a set of virtual QCL resources may be identified as a set of channel prediction resources (CPRs) 730 associated with the CSI report 710. For example, the network node may transmit RRC configurations to the UE for associated CSI reporting settings, which may include (additional or new) IEs related to indicating CPRs 730, including the set of virtual QCL resources 754a-754c.

In some aspects, semi-persistent CSI reporting may be activated via a MAC CE or other similar message. Such a MAC CE may be configured to further indicate the CPR(s) including the set(s) of virtual QCL resources to be reported for the reporting period.

In some other aspects, for aperiodic CSI reporting, an RRC configuration for the associated aperiodic CSI trigger condition may include an additional IE as a CPR, including a set of virtual QCL resources. The UE, however, may be configured to identify the virtual QCL resource to be reported when the trigger condition for aperiodic CSI reporting is fulfilled.

The measurements upon which the report quantities are based may be obtained from the CMRs 720, such as by obtaining measurements from the RS resources 742a-742c. The UE may determine the report quantities for the CPRs 730 based on the measurements obtained from the mother RS resources 742a-742c. The UE may populate a CSI report with a set of related report quantities for one of the sets of virtual QCL resources 754a-754c. The UE may identify the one of the sets of virtual QCL resources 754a-754c in the CSI report, which may indicate a selection of the one of the sets of virtual QCL resources 754a-754c by the UE.

A network node may instruct a UE to transmit a CSI report having one or more report quantities associated with one or more virtual QCL resources. In response, the UE may transmit a CSI report associated with a virtual QCL resource, and the CSI report may indicate at least one of the following report quantities: L1-RSRP, L1-SINR, CQI, RI, PMI, and/or LI. However, some UEs may lack a mechanism with which to indicate a selected or preferred virtual QCL resource. That is, some UEs are able to convey a CSI-RS resource indicator (CRI) in order to indicate a selected or preferred physical beam via which an RS was received; however, UEs would be unable to effectively convey information indicating that a virtual QCL resource has been selected.

In some aspects, a UE may be configured to include a report quantity that indicates a virtual QCL resource in a CSI report. For example, the UE may select the virtual QCL resource as a preferred or recommended beam for a network node to use with the UE. A CRI may be unsuitable or imperfect for this purpose because no physical resource exists on which the UE received an RS to select. Instead, a UE as described herein may be configured to include a report quantity indicative of a virtual QCL resource. Such a report quantity may be referred to as a “virtual QCL resource indicator,” “VRI,” or other terminology. The UE may thus be able to select a virtual QCL resource that the UE prefers or recommends, and the UE may be able to indicate that preferred virtual QCL resource as a VRI in a CSI report, e.g., with an associated L1-RSRP, L1-SINR, CQI, RI, PMI, and/or LI. The UE may be able to employ differential reporting for some associated report quantities, such as L1-RSRP and/or L1-SINR, e.g. where a difference exists between a predicted value and a previously predicted value corresponding to the same virtual QCL resource.

In some aspects, the VRI may be conveyed in a manner similar to that as a network node conveys a virtual QCL resource in a TCI state. For example, a UE may refer to a virtual QCL resource in a VRI by referring to an associated mother RS resource. In some other aspects, the VRI may be configured to carry an index indicative of a resource on which the UE would have received a CSI-RS, had a physical beam been employed to transmit on that resource.

Illustratively, the CPRs 730 may include {N₁, N₂, . . . , N_{K}} virtual QCL resources. The respective Nₖ, k∈{1, 2, . . . , K} virtual QCL resources are associated with a k^{th} mother RS resource. The VRIs that a UE can report in one CSI report may be based on one or more rules, which may be configured to the UE from a network node or preconfigured at the UE according to a standards document. For example, the UE may be configured to generate a CSI report in which all VRIs within the report are associated with the same mother RS resource. In another example, the UE may be configured to address at least one VRI for each of the K mother RS resources. In still another example, the UE may be configured to address at most Mₖ VRI for the k^{th} mother RS resource, and the values of Mₖ, k∈{1, 2, . . . , K} may be configured to the UE by the network node in association with configuring the CSI report.

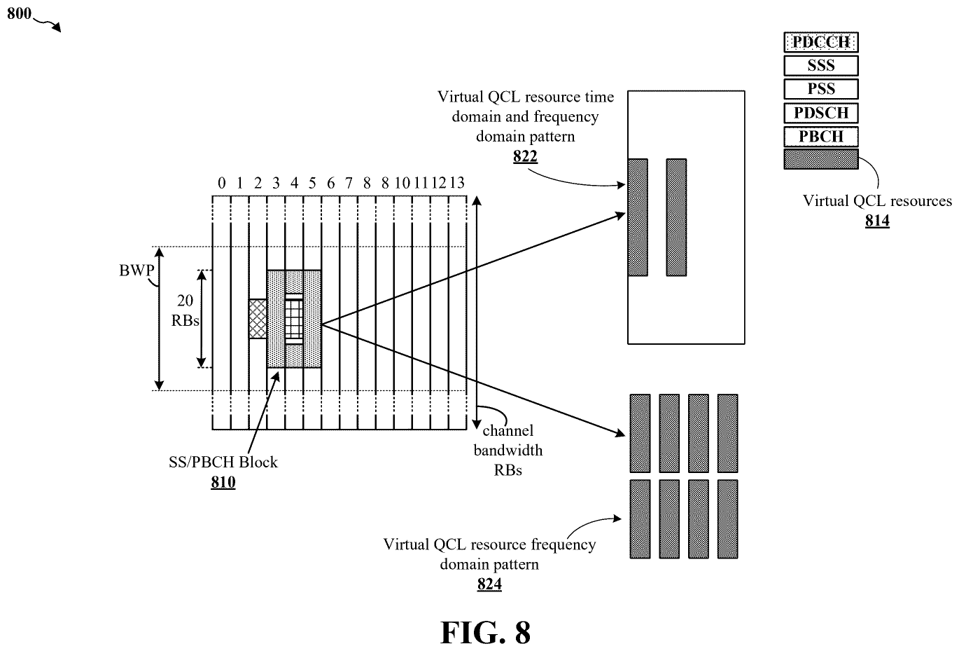

FIG. 8 is a block diagram illustrating example configurations 800 of resource patterns 822, 824 for virtual QCL resources 814. In some aspects, a UE may expect that the CMRs configured for CSI reporting are SSB resources. As illustrated, each SSB 810 may follow a relative uniform pattern in which the PSS starts the SSB 810 in the time domain, followed by the PBCH, and the SSS, and then the PBCH again.

In some aspects, the UE may assume the same pattern 822 in both the time domain and the frequency domain for the virtual QCL resources 814 that correspond with the SSB 810 (that is, the virtual QCL resources 814 of which the SSB 810 is the mother RS resource). The time-frequency domain pattern 822 assumed by the UE to match that of the SSB 810 may include a number of resource elements, and a number of symbols occupied by the virtual QCL resource 814. The UE may predict one or more report quantities (e.g., L1-RSRP, L1-SINR, etc.) or other measurement(s) for the virtual QCL resource 814 using a time-frequency domain pattern 822 that matches that of the mother RS resource (i.e., the SSB 810).

In some other aspects, the UE may be preconfigured with a pattern 824 to use for CSI reporting associated with virtual QCL resources 814. A preconfigured pattern 824 may be established by a standards organization, such as 3GPP. Thus, the UE may neither observe the pattern 824 nor receive a configuration of the pattern 824 because the pattern may be stored in the memory of the UE prior to initial access. In some aspects, a preconfigured pattern 824 may include a number of REs and a number of OFDM symbols occupied by the virtual QCL resource 814 in the frequency domain. The UE may predict one or more report quantities (e.g., L1-RSRP, L1-SINR, etc.) or other measurement(s) for the virtual QCL resource 814 using the preconfigured frequency domain pattern 824.

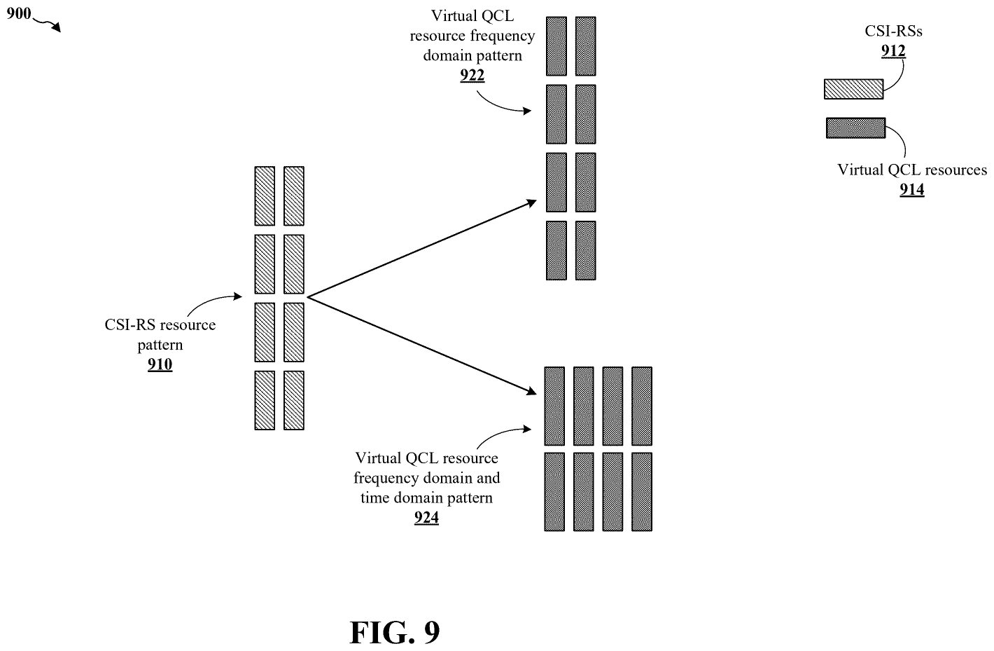

FIG. 9 is a block diagram illustrating example configurations 900 of resource patterns 922, 924 for virtual QCL resources 914. In some aspects, a UE may expect that the CMRs configured for CSI reporting are CSI-RS resources. As illustrated, each CSI-RS 912 may follow a relative uniform pattern 910.

In some aspects, the UE may assume the pattern 910 associated with the CSI-RSs 912 as CMRs is the same as the pattern 922 in the frequency domain for the virtual QCL resources 914 as CPRs that correspond with the CSI-RSs 912 (that is, the virtual QCL resources 914 of which the CSI-RSs 912 are mother RS resources). The frequency domain pattern 922 assumed by the UE to match that of the CSI-RS pattern 910 in the frequency domain may include a number of REs per PRB and a number of PRBs within the active BWP. The UE may predict one or more report quantities (e.g., L1-RSRP, L1-SINR, etc.) or other measurement(s) for the virtual QCL resource 914 using a frequency domain pattern 922 that matches the pattern 910 of the mother RS resource (i.e., the CSI-RS 912).

In some other aspects, the UE may be preconfigured with a pattern 924 to use for CSI reporting associated with virtual QCL resources 914. A preconfigured pattern 924 may be established by a standards organization, such as 3GPP. Thus, the UE may neither observe the pattern 924 nor receive a configuration of the pattern 924 because the pattern may be stored in the memory of the UE prior to initial access. In some aspects, a preconfigured pattern 924 may include a number of REs and a number of OFDM symbols occupied by the virtual QCL resource 914 in the time and frequency domains. The UE may predict one or more report quantities (e.g., L1-RSRP, L1-SINR, etc.) or other measurement(s) for the virtual QCL resource 914 using the preconfigured time-frequency domain pattern 924.

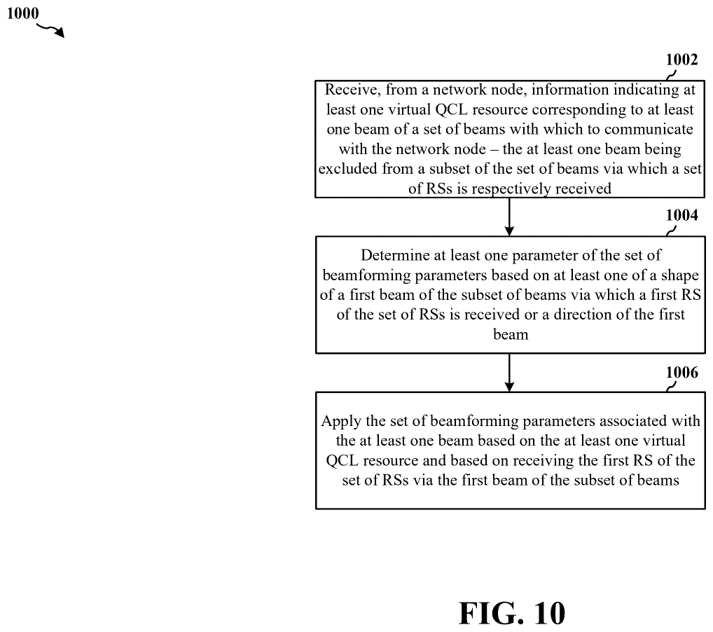

FIG. 10 is a flowchart of a method 1000 of wireless communication. The method 1000 may be performed by or at a UE (e.g., the UE 104, 450), another wireless communications apparatus, or one or more components thereof. According to various different aspects, one or more of the illustrated blocks may be omitted, transposed, and/or contemporaneously performed.

At 1002, the UE may receive, from a network node, information indicating at least one virtual QCL resource corresponding to at least one beam of a set of beams with which to communicate with the network node. The at least one beam may be excluded from a subset of beams of the set of beams via which a set of reference signals is respectively received. In some aspects, the information indicating the at least one virtual QCL resource is received in one of a RRC message, a MAC CE, or a DCI message. Referring to FIG. 5, for example, the UE 504 may receive, from the network node 502, information indicating at least one virtual QCL resource corresponding to at least one of the unused beams 524 with which to communicate with the network node 502. The at least one of the unused beams 524 may be excluded from the used beams 522 via which the set of reference signals 506a-506c (e.g., CSI-RSs or SSBs) is respectively received.

At 1004, the UE may determine at least one parameter of the set of beamforming parameters based on at least one of a shape of a first beam of the subset of beams via which a first RS of the set of RSs is received or a direction of the first beam. For example, the UE may select a coefficient to apply to the beam width of the first beam, and the UE may multiply the beam width of the first beam (e.g., the “mother beam”) by the coefficient in order to obtain a product. The UE may use the product as the beam width of the at least one beam that is excluded from the subset of beams. In some other aspects, the UE may measure a direction of the first beam, e.g., by measuring an AoA at which an RS is received on the first beam. The UE may apply an positive or negative offset to the measured direction of the first beam in order to obtain an angle for the at least one beam that is excluded from the subject of beam. Referring to FIGS. 5 and 6, for example, the UE 504 may determine at least one parameter of the set of beamforming parameters 654 for the virtual QCL resource 634 to be used for the virtual beam 604 based on at least one of the beamforming parameters 652 for the RS resource 642 used for the physical beam 602.

At 1006, the UE may apply the set of beamforming parameters associated with the at least one beam based on the at least one virtual QCL resource and based on receiving the first RS of the set of RSs via the first beam of the subset of beams. For example, the UE may configure a number of antenna elements and/or power thereto to shape the at least one beam based on at least one parameter of the set of beamforming parameters, and the UE may generate the beam in a direction that is based on at least one other parameter of the set of beamforming parameters. The UE may then transmit or receive signaling on a set of resources using the generated beam. Referring to FIGS. 5 and 6, for example, the UE 504 may apply the set of beamforming 654 parameters associated with the virtual beam 604 based on the at least one virtual QCL resource 634 and based on receiving a first RS of a set of RSs (e.g., the RSs 506a-506c) via the physical beam 602.

In some aspects, the UE may be further configured to perform a measurement on a set of time-frequency resources on which the first reference signal is received. The UE may be further configured to determine at least one report quantity for a set of channel prediction resources that is associated with the at least one virtual QCL resource based on the measurement on the set of time-frequency resources. The UE may be further configured to transmit, to the network node, at least one CSI report that indicates the at least one report quantity. In some aspects, the at least one report quantity includes at least one of a RSRP, a SINR, a PMI, a RI, a LI, or CQI.

The UE may be further configured to receive, from the network node, an indication of the set of channel prediction resources, and the set of channel prediction resources is associated with a CSI reporting configuration upon which the at least one CSI report is based. In some aspects, a virtual resource pattern of the set of channel prediction resources corresponds with a physical resource pattern of the set of time-frequency resources in a time domain and a frequency domain. In some other aspects, a virtual resource pattern of the set of channel prediction resources is preconfigured and independent of a physical resource pattern of the set of time-frequency resources. In some aspects, the UE may be further configured to select a first virtual QCL resource of the at least one virtual QCL resource, and the at least one CSI report further indicates the first virtual QCL resource. In some aspects, the information indicating the virtual QCL resource includes a TCI state having a QCL type associated with spatial parameters. In some aspects, the UE may be further configured to determine an L1 RSRP of a signal received via the at least one beam based on applying the beamforming parameters. In some aspects, the UE may be further configured to receive, from the network node, data on a PDSCH via the at least one beam based on applying the beamforming parameters.

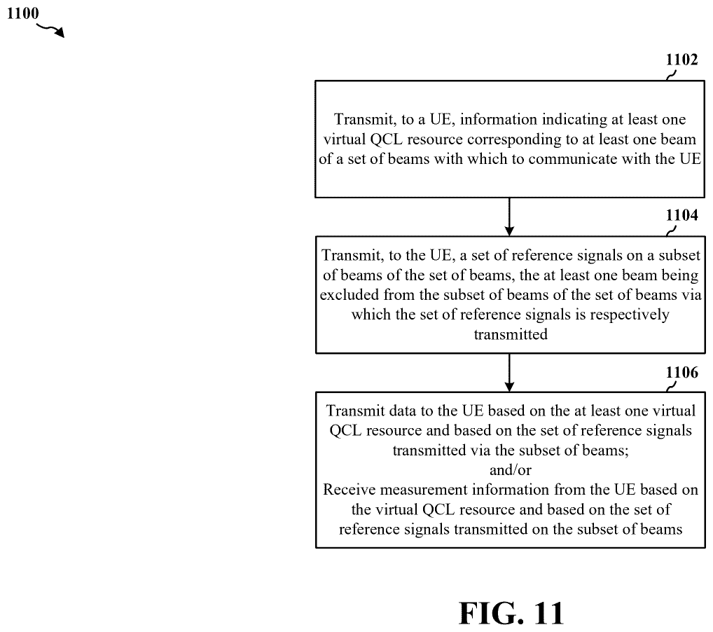

FIG. 11 is a flowchart of a method 1100 of wireless communication. The method 1100 may be performed by or at a network node (e.g., the base station 102/180, 410, the network node 502), another wireless communications apparatus, or one or more components thereof. According to various different aspects, one or more of the illustrated blocks may be omitted, transposed, and/or contemporaneously performed.

At 1102, the network node may transmit, to a UE, information indicating at least one virtual QCL resource corresponding to at least one beam of a set of beams with which to communicate with the UE. In some aspects, the information indicating the at least one virtual QCL resource is transmitted in one of a RRC message, a MAC CE, or a DCI message. In some aspects, the information indicating the virtual QCL resource includes a TCI state having a QCL type associated with spatial parameters.

Referring to FIG. 5, for example, the network node 502 may transmit, to the UE 504, information indicating at least one virtual QCL resource corresponding to at least one of the unused beams 524 with which to communicate with the network node 502. The at least one of the unused beams 524 may be excluded from the used beams 522 via which the set of reference signals 506a-506c (e.g., CSI-RSs or SSBs) is respectively transmitted.

At 1104, the network node may transmit, to the UE, a set of reference signals on a subset of beams of the set of beams, the at least one beam being excluded from the subset of beams of the set of beams via which the set of reference signals is respectively transmitted. Referring to FIGS. 5 and 6, for example, the network node 502 may transmit, to the UE 504, the set of RSs 506a-506c on the set of used beams 522, which may include the physical beam 602. The set of unused beams 524, including the virtual beam 604, may be excluded from the set of used beams 522 via which the set of reference signals 506a-506c is respectively transmitted.

At 1106, the network node may at least one of: transmit data to the UE based on the at least one virtual QCL resource and based on the set of reference signals transmitted via the subset of beams, and/or receive measurement information from the UE based on the virtual QCL resource and based on the set of reference signals transmitted on the subset of beams. In some aspects, the data is transmitted to the UE on a PDSCH, and/or the measurement information includes a L1-RSRP associated with the virtual QCL resource. In some aspects, at least one of the transmitting the data to or receiving the information from the UE is based on at least one of a shape of a first beam of the subset of beams via which a first reference signal of the set of reference signals is transmitted or a direction of the first beam.

Referring to FIGS. 5 and 6, for example, the network node 502 may at least one of: transmit data to the UE 504 based on the at least one virtual QCL resource 634 and based on the set of reference signals 506a-506c transmitted via the used beams 522, and/or receive measurement information from the UE 504 based on the at least one virtual QCL resource 634 and based on the set of reference signals 506a-506c transmitted via the used beams 522.

In some aspects, the network node may be further configured to transmit, to the UE, an indication of a set of channel prediction resources associated with a CSI reporting configuration, and each channel prediction resource of the set of channel prediction resources corresponds to a respective virtual QCL resource of the at least one virtual QCL resource. In some aspects, the network node may be further configured to receive, from the UE, at least one CSI report indicating at least one report quantity associated with at least one channel prediction resource of the set of channel predictions resources based on the CSI reporting configuration, and the at least one report quantity may be based on one of the set of reference signals transmitted via one of the subset of beams. In some aspects, the at least one report quantity includes at least one of a RSRP, a SINR, a PMI, an RI, an LI, or CQI. In some aspects, a virtual resource pattern of the set of channel prediction resources corresponds in a time domain and a frequency domain with a physical resource pattern of a set of time-frequency resources carrying the set of reference signals. In some aspects, a virtual resource pattern of the set of channel prediction resources is preconfigured and independent of a physical resource pattern of a set of time-frequency resources carrying the set of reference signals. In some aspects, the at least one CSI report further indicates a first virtual QCL resource of the at least one virtual QCL resource.

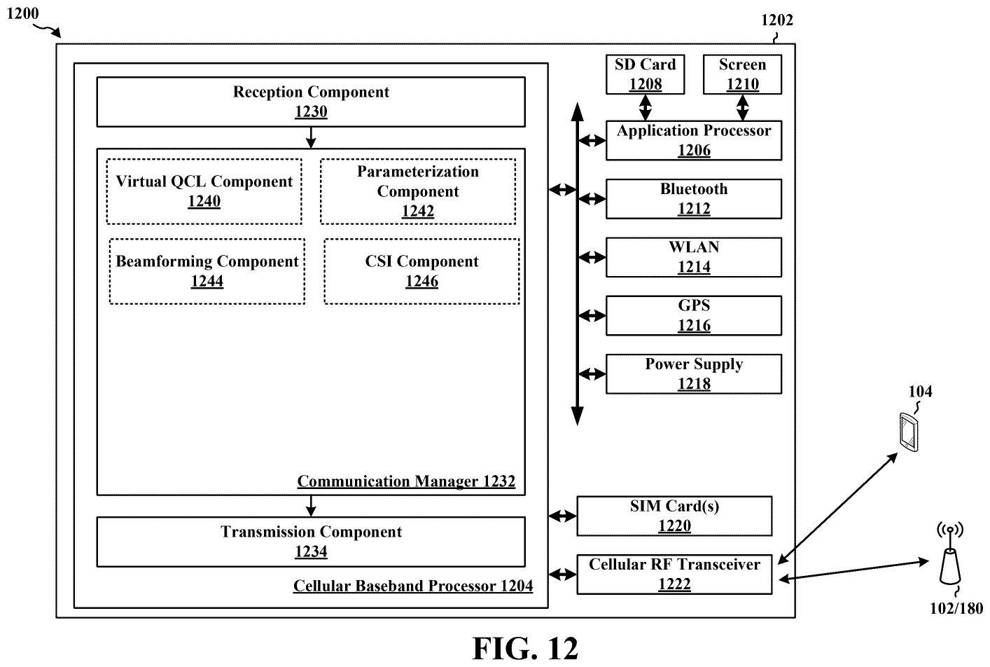

FIG. 12 is a diagram 1200 illustrating an example of a hardware implementation for an apparatus 1202. The apparatus 1202 may be a UE or similar device, or the apparatus 1202 may be a component of a UE or similar device. The apparatus 1202 may include a cellular baseband processor 1204 (also referred to as a modem) and/or a cellular RF transceiver 1222, which may be coupled together and/or integrated into the same package, component, circuit, chip, and/or other circuitry.

In some aspects, the apparatus 1202 may accept or may include one or more subscriber identity modules (SIM) cards 1220, which may include one or more integrated circuits, chips, or similar circuitry, and which may be removable or embedded. The one or more SIM cards 1220 may carry identification and/or authentication information, such as an international mobile subscriber identity (IMSI) and/or IMSI-related key(s). Further, the apparatus 1202 may include one or more of an application processor 1206 coupled to a secure digital (SD) card 1208 and a screen 1210, a Bluetooth module 1212, a wireless local area network (WLAN) module 1214, a Global Positioning System (GPS) module 1216, and/or a power supply 1218.

The cellular baseband processor 1204 communicates through the cellular RF transceiver 1222 with the UE 104 and/or base station 102/180. The cellular baseband processor 1204 may include a computer-readable medium/memory. The computer-readable medium / memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium / memory and/or configured as hardware within the cellular baseband processor 1204.

In the context of FIG. 4, the cellular baseband processor 1204 may be a component of the UE 450 and may include the memory 460 and/or at least one of the TX processor 468, the RX processor 456, and/or the controller/processor 459. In one configuration, the apparatus 1202 may be a modem chip and/or may be implemented as the baseband processor 1204, while in another configuration, the apparatus 1202 may be the entire UE (e.g., the UE 450 of FIG. 4) and may include some or all of the abovementioned components, circuits, chips, and/or other circuitry illustrated in the context of the apparatus 1202. In one configuration, the cellular RF transceiver 1222 may be implemented as at least one of the transmitter 454TX and/or the receiver 454RX.

The reception component 1230 may be configured to receive signaling on a wireless channel, such as signaling from a base station 102/180 or UE 104. The transmission component 1234 may be configured to transmit signaling on a wireless channel, such as signaling to a base station 102/180 or UE 104. The communication manager 1232 may coordinate or manage some or all wireless communications by the apparatus 1202, including across the reception component 1230 and the transmission component 1234.

The reception component 1230 may provide some or all data and/or control information included in received signaling to the communication manager 1232, and the communication manager 1232 may generate and provide some or all of the data and/or control information to be included in transmitted signaling to the transmission component 1234. The communication manager 1232 may include the various illustrated components, including one or more components configured to process received data and/or control information, and/or one or more components configured to generate data and/or control information for transmission.

The communication manager 1232 includes a virtual QCL component 1240, a parameterization component 1242, and a beamforming component 1244, and a CSI component 1246. The virtual QCL component 1240 may obtain, from a base station 102/180, information indicating at least one virtual QCL resource corresponding to at least one beam of a set of beams with which to communicate with the base station 102/180, as described in connection with 1002 of FIG. 10. The at least one beam may be excluded from a subset of beams of the set of beams via which a set of reference signals is respectively received. In some aspects, the information indicating the at least one virtual QCL resource is received in one of a RRC message, a MAC CE, or a DCI message.

The parameterization component 1242 may determine at least one parameter of the set of beamforming parameters based on at least one of a shape of a first beam of the subset of beams via which a first RS of the set of RSs is received or a direction of the first beam, e.g., as described in connection with 1004 of FIG. 10. For example, the parameterization component 1242 may select a coefficient to apply to the beam width of the first beam, and the parameterization component 1242 may multiply the beam width of the first beam (e.g., the “mother beam”) by the coefficient in order to obtain a product. The parameterization component 1242 may use the product as the beam width of the at least one beam that is excluded from the subset of beams. In some other aspects, the parameterization component 1242 may measure a direction of the first beam, e.g., by measuring an AoA at which an RS is received on the first beam. The parameterization component 1242 may apply an positive or negative offset to the measured direction of the first beam in order to obtain an angle for the at least one beam that is excluded from the subject of beam.

The beamforming component 1244 may apply the set of beamforming parameters associated with the at least one beam based on the at least one virtual QCL resource and based on receiving the first RS of the set of RSs via the first beam of the subset of beams, e.g., as described in connection with 1006 of FIG. 10. For example, the beamforming component 1244 may configure a number of antenna elements and/or power thereto to shape the at least one beam based on at least one parameter of the set of beamforming parameters, and the beamforming component 1244 may generate the beam in a direction that is based on at least one other parameter of the set of beamforming parameters. The beamforming component 1244 may then transmit or receive signaling on a set of resources using the generated beam.

In some aspects, the apparatus 1002 may further include a CSI component 1246 that is configured to perform a measurement on a set of time-frequency resources on which the first reference signal is received. The CSI component 1246 may be further configured to determine at least one report quantity for a set of channel prediction resources that is associated with the at least one virtual QCL resource based on the measurement on the set of time-frequency resources. The CSI component 1246 may be further configured to transmit, to the base station 102/180, at least one CSI report that indicates the at least one report quantity. In some aspects, the at least one report quantity includes at least one of a RSRP, a SINR, a PMI, a RI, a LI, or CQI.

The CSI component 1246 may be further configured to receive, from the base station 102/180, an indication of the set of channel prediction resources, and the set of channel prediction resources is associated with a CSI reporting configuration upon which the at least one CSI report is based. In some aspects, a virtual resource pattern of the set of channel prediction resources corresponds with a physical resource pattern of the set of time-frequency resources in a time domain and a frequency domain. In some other aspects, a virtual resource pattern of the set of channel prediction resources is preconfigured and independent of a physical resource pattern of the set of time-frequency resources. In some aspects, the CSI component 1246 may be further configured to select a first virtual QCL resource of the at least one virtual QCL resource, and the at least one CSI report further indicates the first virtual QCL resource. In some aspects, the information indicating the virtual QCL resource includes a TCI state having a QCL type associated with spatial parameters. In some aspects, the CSI component 1246 may be further configured to determine an L1 RSRP of a signal received via the at least one beam based on applying the beamforming parameters. In some aspects, the reception component 1230 may be further configured to receive, from the base station 102/180, data on a PDSCH via the at least one beam based on applying the beamforming parameters.

The apparatus 1202 may include additional components that perform some or all of the blocks, operations, signaling, etc. of the algorithm(s) in the aforementioned call flow diagram and/or flowchart of FIG. 10. As such, some or all of the blocks, operations, signaling, etc. in the aforementioned call flow diagram and/or flowchart of FIG. 10 may be performed by one or more components and the apparatus 1202 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for receiving, from a network node, information indicating at least one virtual QCL resource corresponding to at least one beam of a set of beams with which to communicate with the network node, the at least one beam being excluded from a subset of beams of the set of beams via which a set of reference signals is respectively received; and means for applying a set of beamforming parameters associated with the at least one beam based on the at least one virtual QCL resource and based on receiving a first reference signal of the set of reference signals via a first beam of the subset of beams.

In one configuration, the information indicating the at least one virtual QCL resource is received in one of a RRC message, a MAC CE, or a DCI message.

In one configuration, the apparatus 1202, and in particular the cellular baseband processor 1204, includes means for determining at least one parameter of the set of beamforming parameters based on at least one of a shape of the first beam or a direction of the first beam.

In one configuration, the apparatus 1202, and in particular the cellular baseband processor 1204, includes means for performing a measurement on a set of time-frequency resources on which the first reference signal is received; means for determining at least one report quantity for a set of channel prediction resources that is associated with the at least one virtual QCL resource based on the measurement on the set of time-frequency resources; and means for transmitting, to the network node, at least one CSI report that indicates the at least one report quantity.

In one configuration, the apparatus 1202, and in particular the cellular baseband processor 1204, includes means for receiving, from the network node, an indication of the set of channel prediction resources, and the set of channel prediction resources is associated with a CSI reporting configuration upon which the at least one CSI report is based.

In one configuration, the at least one report quantity includes at least one of a RSRP, a SINR, a PMI, an RI, an LI, or CQI.

In one configuration, a virtual resource pattern of the set of channel prediction resources corresponds with a physical resource pattern of the set of time-frequency resources in a time domain and a frequency domain.

In one configuration, a virtual resource pattern of the set of channel prediction resources is preconfigured and independent of a physical resource pattern of the set of time-frequency resources.

In one configuration, the apparatus 1202, and in particular the cellular baseband processor 1204, includes means for selecting a first virtual QCL resource of the at least one virtual QCL resource, and the at least one CSI report further indicates the first virtual QCL resource.

In one configuration, the information indicating the virtual QCL resource includes a TCI state having a QCL type associated with spatial parameters.

In one configuration, the apparatus 1202, and in particular the cellular baseband processor 1204, includes means for determining an L1-RSRP of a signal received via the at least one beam based on applying the beamforming parameters.

In one configuration, the apparatus 1202, and in particular the cellular baseband processor 1204, includes means for receiving, from the network node, data on a PDSCH via the at least one beam based on applying the beamforming parameters.

The aforementioned means may be one or more of the aforementioned components of the apparatus 1202 configured to perform the functions recited by the aforementioned means. As described supra, the apparatus 1202 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

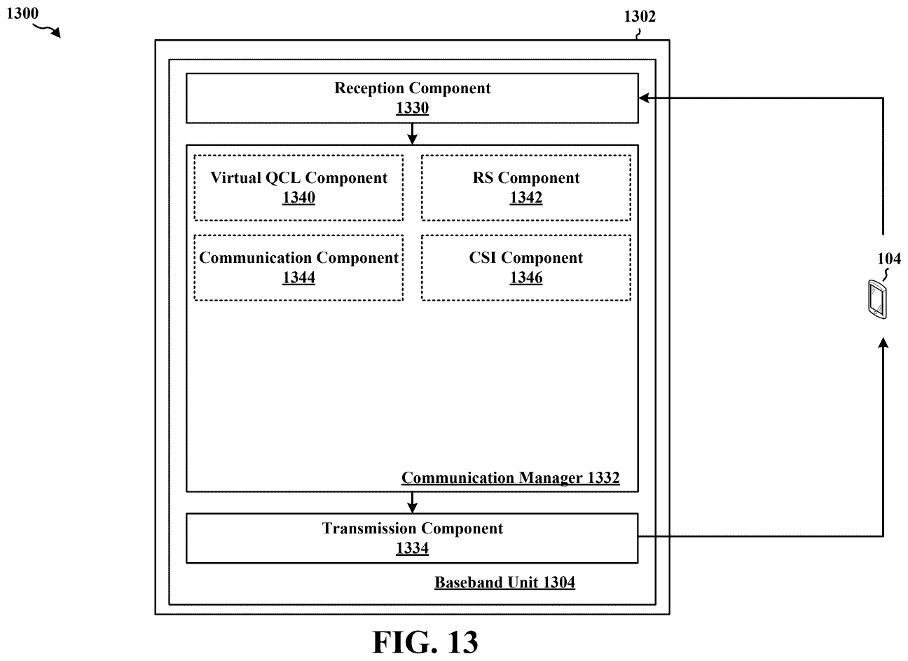

FIG. 13 is a diagram 1300 illustrating an example of a hardware implementation for an apparatus 1302. The apparatus 1302 may be a base station or similar device or system, or the apparatus 1302 may be a component of a base station or similar device or system. The apparatus 1302 may include a baseband unit 1304. The baseband unit 1304 may communicate through a cellular RF transceiver. For example, the baseband unit 1304 may communicate through a cellular RF transceiver with a UE 104, such as for downlink and/or uplink communication, and/or with a base station 102/180, such as for IAB.

The baseband unit 1304 may include a computer-readable medium/memory, which may be non-transitory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 410 and may include the memory 476 and/or at least one of the TX processor 416, the RX processor 470, and the controller/processor 475.

The reception component 1330 may be configured to receive signaling on a wireless channel, such as signaling from a UE 104 or base station 102/180. The transmission component 1334 may be configured to transmit signaling on a wireless channel, such as signaling to a UE 104 or base station 102/180. The communication manager 1332 may coordinate or manage some or all wireless communications by the apparatus 1302, including across the reception component 1330 and the transmission component 1334.

The reception component 1330 may provide some or all data and/or control information included in received signaling to the communication manager 1332, and the communication manager 1332 may generate and provide some or all of the data and/or control information to be included in transmitted signaling to the transmission component 1334. The communication manager 1332 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1332 includes a virtual QCL component 1240, an RS component 1342, a communication component 1344, and a CSI component 1346. The virtual QCL component 1340 may transmit, to a UE 104, information indicating at least one virtual QCL resource corresponding to at least one beam of a set of beams with which to communicate with the UE 104, e.g., as described in connection with 1102 of FIG. 11. In some aspects, the information indicating the at least one virtual QCL resource is transmitted in one of a RRC message, a MAC CE, or a DCI message. In some aspects, the information indicating the virtual QCL resource includes a TCI state having a QCL type associated with spatial parameters.

The RS component 1342 may transmit, to the UE 104, a set of reference signals on a subset of beams of the set of beams, e.g., as described in connection with 1104 of FIG. 11. The at least one beam may be excluded from the subset of beams of the set of beams via which the set of reference signals is respectively transmitted.

The communication component 1344 may at least one of: transmit data to the UE 104 based on the at least one virtual QCL resource and based on the set of reference signals transmitted via the subset of beams, and/or receive measurement information from the UE 104 based on the virtual QCL resource and based on the set of reference signals transmitted on the subset of beams, e.g., as described in connection with 1106 of FIG. 11. In some aspects, the data is transmitted to the UE 104 on a PDSCH, and/or the measurement information includes a L1-RSRP associated with the virtual QCL resource. In some aspects, at least one of the transmitting the data to or receiving the information from the UE 104 is based on at least one of a shape of a first beam of the subset of beams via which a first reference signal of the set of reference signals is transmitted or a direction of the first beam.

In some aspects, the CSI component 1346 may be further configured to transmit, to the UE 104, an indication of a set of channel prediction resources associated with a CSI reporting configuration, and each channel prediction resource of the set of channel prediction resources corresponds to a respective virtual QCL resource of the at least one virtual QCL resource. In some aspects, the CSI component 1346 may be further configured to receive, from the UE 104, at least one CSI report indicating at least one report quantity associated with at least one channel prediction resource of the set of channel predictions resources based on the CSI reporting configuration, and the at least one report quantity may be based on one of the set of reference signals transmitted via one of the subset of beams. In some aspects, the at least one report quantity includes at least one of a RSRP, a SINR, a PMI, an RI, an LI, or CQI. In some aspects, a virtual resource pattern of the set of channel prediction resources corresponds in a time domain and a frequency domain with a physical resource pattern of a set of time-frequency resources carrying the set of reference signals. In some aspects, a virtual resource pattern of the set of channel prediction resources is preconfigured and independent of a physical resource pattern of a set of time-frequency resources carrying the set of reference signals. In some aspects, the at least one CSI report further indicates a first virtual QCL resource of the at least one virtual QCL resource.

The apparatus 1302 may include additional components that perform some or all of the blocks, operations, signaling, etc. of the algorithm(s) in the aforementioned call flow diagram and/or flowchart of FIG. 11. As such, some or all of the blocks, operations, signaling, etc. in the aforementioned call flow diagram and/or flowchart of FIG. 11 may be performed by a component and the apparatus 1302 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for transmitting, to a UE, information indicating at least one virtual QCL resource corresponding to at least one beam of a set of beams with which to communicate with the UE; and means for transmitting, to the UE, a set of reference signals on a subset of beams of the set of beams, the at least one beam being excluded from the subset of beams of the set of beams via which the set of reference signals is respectively transmitted.

In one configuration, the apparatus 1302, and in particular the baseband unit 1304, includes at least one of: means for transmitting data to the UE based on the at least one virtual QCL resource and based on the set of reference signals transmitted via the subset of beams, or means for receiving measurement information from the UE based on the virtual QCL resource and based on the set of reference signals transmitted on the subset of beams.

In one configuration, at least one of: the data is transmitted to the UE on a PDSCH, or the measurement information includes a L1-RSRP associated with the virtual QCL resource.

In one configuration, at least one of the transmitting the data to or receiving the information from the UE is based on at least one of a shape of a first beam of the subset of beams via which a first reference signal of the set of reference signals is transmitted or a direction of the first beam.

In one configuration, the information indicating the at least one virtual QCL resource is transmitted in one of a RRC message, a MAC CE, or a DCI message.

In one configuration, the apparatus 1302, and in particular the baseband unit 1304, includes means for transmitting, to the UE, an indication of a set of channel prediction resources associated with a CSI reporting configuration, and each channel prediction resource of the set of channel prediction resources corresponds to a respective virtual QCL resource of the at least one virtual QCL resource; and means for receiving, from the UE, at least one CSI report indicating at least one report quantity associated with at least one channel prediction resource of the set of channel predictions resources based on the CSI reporting configuration, and the at least one report quantity is based on one of the set of reference signals transmitted via one of the subset of beams.

In one configuration, the at least one report quantity includes at least one of a RSRP, a SINR, a PMI, an RI, an LI, or CQI.

In one configuration, a virtual resource pattern of the set of channel prediction resources corresponds in a time domain and a frequency domain with a physical resource pattern of a set of time-frequency resources carrying the set of reference signals.

In one configuration, a virtual resource pattern of the set of channel prediction resources is preconfigured and independent of a physical resource pattern of a set of time-frequency resources carrying the set of reference signals.

In one configuration, the at least one CSI report further indicates a first virtual QCL resource of the at least one virtual QCL resource.

In one configuration, the information indicating the virtual QCL resource includes a TCI state having a QCL type associated with spatial parameters.

The aforementioned means may be one or more of the aforementioned components of the apparatus 1302 configured to perform the functions recited by the aforementioned means. As described supra, the apparatus 1302 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

The following examples are illustrative only and may be combined with aspects of other embodiments or teachings described herein, without limitation.

Example 1 is a method of wireless communication at a UE, including: receiving, from a network node, information indicating at least one virtual QCL resource corresponding to at least one beam of a set of beams with which to communicate with the network node, the at least one beam being excluded from a subset of beams of the set of beams via which a set of reference signals is respectively received; and applying a set of beamforming parameters associated with the at least one beam based on the at least one virtual QCL resource and based on receiving a first reference signal of the set of reference signals via a first beam of the subset of beams.

Example 2 is the method of Example 1, and the information indicating the at least one virtual QCL resource is received in one of a RRC message, a MAC CE, or a DCI message.

Example 3 is the method of Example 1, further including: determining at least one parameter of the set of beamforming parameters based on at least one of a shape of the first beam or a direction of the first beam.

Example 4 is the method of Example 1, further including: performing a measurement on a set of time-frequency resources on which the first reference signal is received; determining at least one report quantity for a set of channel prediction resources that is associated with the at least one virtual QCL resource based on the measurement on the set of time-frequency resources; and transmitting, to the network node, at least one CSI report that indicates the at least one report quantity.

Example 5 is the method of Example 4, further including: receiving, from the network node, an indication of the set of channel prediction resources, and the set of channel prediction resources is associated with a CSI reporting configuration upon which the at least one CSI report is based.

Example 6 is the method of Example 4, and the at least one report quantity includes at least one of a RSRP, a SINR, a PM), a RI, a LI, or CQI.

Example 7 is the method of Example 4, and a virtual resource pattern of the set of channel prediction resources corresponds with a physical resource pattern of the set of time-frequency resources in a time domain and a frequency domain.

Example 8 is the method of Example 4, and a virtual resource pattern of the set of channel prediction resources is preconfigured and independent of a physical resource pattern of the set of time-frequency resources.

Example 9 is the method of Example 4, further including: selecting a first virtual QCL resource of the at least one virtual QCL resource, and the at least one CSI report further indicates the first virtual QCL resource.

Example 10 is the method of Example 1, and the information indicating the virtual QCL resource includes a TCI state having a QCL type associated with spatial parameters.

Example 11 is the method of Example 1, further including: determining a L1-RSRP of a signal received via the at least one beam based on applying the beamforming parameters.

Example 12 is the method of Example 1, further including: receiving, from the network node, data on a PDSCH via the at least one beam based on applying the beamforming parameters.

Example 13 is method of wireless communication at a network node, including: transmitting, to a UE, information indicating at least one virtual QCL resource corresponding to at least one beam of a set of beams with which to communicate with the UE; and transmitting, to the UE, a set of reference signals on a subset of beams of the set of beams, the at least one beam being excluded from the subset of beams of the set of beams via which the set of reference signals is respectively transmitted.

Example 14 is the method of Example 13, further including at least one of: transmitting data to the UE based on the at least one virtual QCL resource and based on the set of reference signals transmitted via the subset of beams, or receiving measurement information from the UE based on the virtual QCL resource and based on the set of reference signals transmitted on the subset of beams.

Example 15 is the method of Example 14, and at least one of: the data is transmitted to the UE on a PDSCH, or the measurement information includes a L1-RSRP associated with the virtual QCL resource.

Example 16 is the method of Example 14, and at least one of the transmitting the data to or receiving the information from the UE is based on at least one of a shape of a first beam of the subset of beams via which a first reference signal of the set of reference signals is transmitted or a direction of the first beam.

Example 17 is the method of Example 13, and the information indicating the at least one virtual QCL resource is transmitted in one of a RRC message, a MAC CE, or a DCI message.

Example 18 is the method of Example 13, further including: transmitting, to the UE, an indication of a set of channel prediction resources associated with a CSI reporting configuration, and each channel prediction resource of the set of channel prediction resources corresponds to a respective virtual QCL resource of the at least one virtual QCL resource; and receiving, from the UE, at least one CSI report indicating at least one report quantity associated with at least one channel prediction resource of the set of channel predictions resources based on the CSI reporting configuration, and the at least one report quantity is based on one of the set of reference signals transmitted via one of the subset of beams.

Example 19 is the method of Example 18, and the at least one report quantity includes at least one of a RSRP, a SINR, a PMI, a RI, a LI, or CQI.

Example 20 is the method of Example 18, and a virtual resource pattern of the set of channel prediction resources corresponds in a time domain and a frequency domain with a physical resource pattern of a set of time-frequency resources carrying the set of reference signals.

Example 21 is the method of Example 18, and a virtual resource pattern of the set of channel prediction resources is preconfigured and independent of a physical resource pattern of a set of time-frequency resources carrying the set of reference signals.

Example 22 is the method of Example 18, and the at least one CSI report further indicates a first virtual QCL resource of the at least one virtual QCL resource.

Example 23 is the method of Example 13, and the information indicating the virtual QCL resource includes a TCI state having a QCL type associated with spatial parameters.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
receiving, from a network node, information indicating at least one virtual quasi-colocation (QCL) resource corresponding to at least one beam of a set of beams with which to communicate with the network node, the at least one beam being excluded from a subset of beams of the set of beams via which a set of reference signals is respectively received; and
applying a set of beamforming parameters associated with the at least one beam based on the at least one virtual QCL resource and based on receiving a first reference signal of the set of reference signals via a first beam of the subset of beams.

2. The method of claim 1, wherein the information indicating the at least one virtual QCL resource is received in one of a radio resource control (RRC) message, a medium access control (MAC) control element (CE), or a downlink control information (DCI) message.

3. The method of claim 1, further comprising:
determining at least one parameter of the set of beamforming parameters based on at least one of a shape of the first beam or a direction of the first beam.

4. The method of claim 1, further comprising:
performing a measurement on a set of time-frequency resources on which the first reference signal is received;
determining at least one report quantity for a set of channel prediction resources that is associated with the at least one virtual QCL resource based on the measurement on the set of time-frequency resources; and
transmitting, to the network node, at least one channel state information (CSI) report that indicates the at least one report quantity.

5. The method of claim 4, further comprising:
receiving, from the network node, an indication of the set of channel prediction resources, wherein the set of channel prediction resources is associated with a CSI reporting configuration upon which the at least one CSI report is based.

6. The method of claim 4, wherein the at least one report quantity comprises at least one of a reference signal received power (RSRP), a signal-to-interference-plus-noise ratio (SINR), a precoding matrix indicator (PMI), a rank indicator (RI), a layer indicator (LI), or channel quality information (CQI).

7. The method of claim 4, wherein a virtual resource pattern of the set of channel prediction resources corresponds with a physical resource pattern of the set of time-frequency resources in a time domain and a frequency domain.

8. The method of claim 4, wherein a virtual resource pattern of the set of channel prediction resources is preconfigured and independent of a physical resource pattern of the set of time-frequency resources.

9. The method of claim 4, further comprising:
selecting a first virtual QCL resource of the at least one virtual QCL resource, wherein the at least one CSI report further indicates the first virtual QCL resource.

10. The method of claim 1, wherein the information indicating the at least one virtual QCL resource comprises a transmission configuration indicator (TCI) state having a QCL type associated with spatial parameters.

11. The method of claim 1, further comprising:
determining a layer 1 (L1) reference signal receive power (RSRP) of a signal received via the at least one beam based on applying the set of beamforming parameters.

12. The method of claim 1, further comprising:
receiving, from the network node, data on a physical downlink shared channel (PDSCH) via the at least one beam based on applying the set of beamforming parameters.

13. A method of wireless communication at a network node, comprising:
transmitting, to a user equipment (UE), information indicating at least one virtual quasi-colocation (QCL) resource corresponding to at least one beam of a set of beams with which to communicate with the UE; and
transmitting, to the UE, a set of reference signals on a subset of beams of the set of beams, the at least one beam being excluded from the subset of beams of the set of beams via which the set of reference signals is respectively transmitted.

14. The method of claim 13, further comprising at least one of:
transmitting data to the UE based on the at least one virtual QCL resource and based on the set of reference signals transmitted via the subset of beams, or
receiving measurement information from the UE based on the at least one virtual QCL resource and based on the set of reference signals transmitted on the subset of beams.

15. The method of claim 14, wherein at least one of:
the data is transmitted to the UE on a physical downlink shared channel (PDSCH), or
the measurement information comprises a layer 1 (L1) reference signal receive power (RSRP) associated with the at least one virtual QCL resource.

16. The method of claim 14, wherein at least one of the transmitting the data to or receiving the information from the UE is based on at least one of a shape of a first beam of the subset of beams via which a first reference signal of the set of reference signals is transmitted or a direction of the first beam.

17. The method of claim 13, wherein the information indicating the at least one virtual QCL resource is transmitted in one of a radio resource control (RRC) message, a medium access control (MAC) control element (CE), or a downlink control information (DCI) message.

18. The method of claim 13, further comprising:
transmitting, to the UE, an indication of a set of channel prediction resources associated with a channel state information (CSI) reporting configuration, wherein each channel prediction resource of the set of channel prediction resources corresponds to a respective virtual QCL resource of the at least one virtual QCL resource; and
receiving, from the UE, at least one CSI report indicating at least one report quantity associated with at least one channel prediction resource of the set of channel predictions resources based on the CSI reporting configuration, wherein the at least one report quantity is based on one of the set of reference signals transmitted via one of the subset of beams.

19. The method of claim 18, wherein the at least one report quantity comprises at least one of a reference signal received power (RSRP), a signal-to-interference-plus-noise ratio (SINR), a precoding matrix indicator (PMI), a rank indicator (RI), a layer indicator (LI), or channel quality information (CQI).

20-23. (canceled)

24. An apparatus for wireless communication at a user equipment (UE), comprising:
a memory; and
at least one processor coupled to the memory and configured to:
receive, from a network node, information indicating at least one virtual quasi-colocation (QCL) resource corresponding to at least one beam of a set of beams with which to communicate with the network node, the at least one beam being excluded from a subset of beams of the set of beams via which a set of reference signals is respectively received; and
apply a set of beamforming parameters associated with the at least one beam based on the at least one virtual QCL resource and based on receiving a first reference signal of the set of reference signals via a first beam of the subset of beams.

25-30. (canceled)
